(19) United States
(12) Patent Application Publication
(10) Pub. No.: US 2012/0162969 A1
(43) Pub. Date: Jun. 28, 2012

(54) NATIVITY SHINING STAR WITH RAYS

(76) Inventor: Macario Mallari, Carteret, NJ (US)

(21) Appl. No.: 13/336,998

(22) Filed: Dec. 23, 2011

Related U.S. Application Data
(60) Provisional application No. 61/426,829, filed on Dec. 23, 2010.

(51) Int. Cl. F21S 6/00

(52) U.S. Cl. 362/121

(57) ABSTRACT

Christmas is a holiday that is observed by people all over the world where the most common scene displayed is the nativity scene. Typically the nativity scene is a stable with a baby lying in a cradle and surrounded by individuals and animals. While the nativity sets may include a lighted star, unfortunately, they do not include a star where the rays of the star actually shine on and illuminate the manger. The present invention comprises a first pole which supports a lighted star and a spotlight that is oriented to illuminate the nativity scene. The present invention further comprises a second pole located near the nativity set. Glittering strings stretched from the lighted star to the second pole together with the focused illumination from the spotlight provides the RAYS that emulates the rays of the star shined on the manger and led the three Kings to the newborn Jesus.

### REFERENCE TO RELATED APPLICATIONS

This patent application claims the benefit of U.S. Provisional Application No. 61/426,829 filed on Dec. 23, 2010, the disclosure of which is incorporated herein by reference in its entirety.

### BACKGROUND OF THE INVENTION

1. Field of the Invention

This invention relates generally to an apparatus that can be used with a nativity set and more specifically to a shining star having at least one bright lighted ray located on a telescoping pole.

2. Description of the Prior Art

Christmas is a holiday that is observed by people in almost all countries of the world where the most common scene that is displayed is the nativity scene. Typically the nativity scene is a stable with a baby lying in a cradle and surrounded by individuals and animals. Also included in the scene is the shining star that led the three Kings to the newborn King.

Unfortunately, while the nativity sets may include a lighted star, they do not include a star where the rays of the star actually shine on and illuminate the manger that led the three Kings to the newborn King.

Clearly, what is desired in a nativity scene is a lighted star that has at least one ray of light that shines on and illuminates the nativity scene.

### SUMMARY OF THE INVENTION

The primary object of the present invention is to provide a lighted star that has at least one ray of light that shines on and illuminates the nativity scene.

A free standing lighted star ornament according to the present invention comprises a free standing tubular support pole which has a bottom section that can be driven into the ground and a plurality of intermediate sections that extend from the bottom section to a top section. A lighted star, a spot light and a hook or loop to which glittering strings or glittering strips material can be attached is located at the very top of the top section. The length of each section including top, intermediate and bottom, and the number of intermediate sections and the total height of the tubular support can vary.

As noted, existing Christmas nativity sets are missing a very important piece, the RAYS of the star that shined on the manger and led the three Kings to the newborn Jesus. This invention fills that gap.

The present invention further comprises a pole designed to be located near a nativity set is partially buried in the ground or attached to a container for support. The pole has a plurality of hooks to which glittering strings or strips of glittering fabric or plastic can be attached. The glittering strings or strips stretched from the hook or loop near the lighted star to the pole near the nativity scene in combination with the spotlight that is oriented to illuminate the nativity scene provide and emulate the rays of the star that shined on the manger and led the three Kings to the newborn Jesus.

The invention disclosed can be used with existing nativity sets, indoor or outdoor, to depict the star with its glittering rays of strings or strips of fabric or plastic lighting up the manger. The height of the star can be adjusted. The length and brightness of the rays from the star can be adjusted. The length of the rays from the star to the manger can be adjusted. The intensity of the rays is adjustable. The rays can also be steady, flickering or running.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of a free standing lighted star in combination with a spot light and glittering strings for use outdoors that can be oriented to shine on and illuminate an object located on the ground; and

FIG. 2 is a view of another embodiment of a free standing lighted star in combination with a spot light and glittering strings that can be oriented to shine on and illuminate an object located in an enclosed area such as a large room or an indoor arena.

### DESCRIPTION OF THE DISCLOSED EMBODIMENT

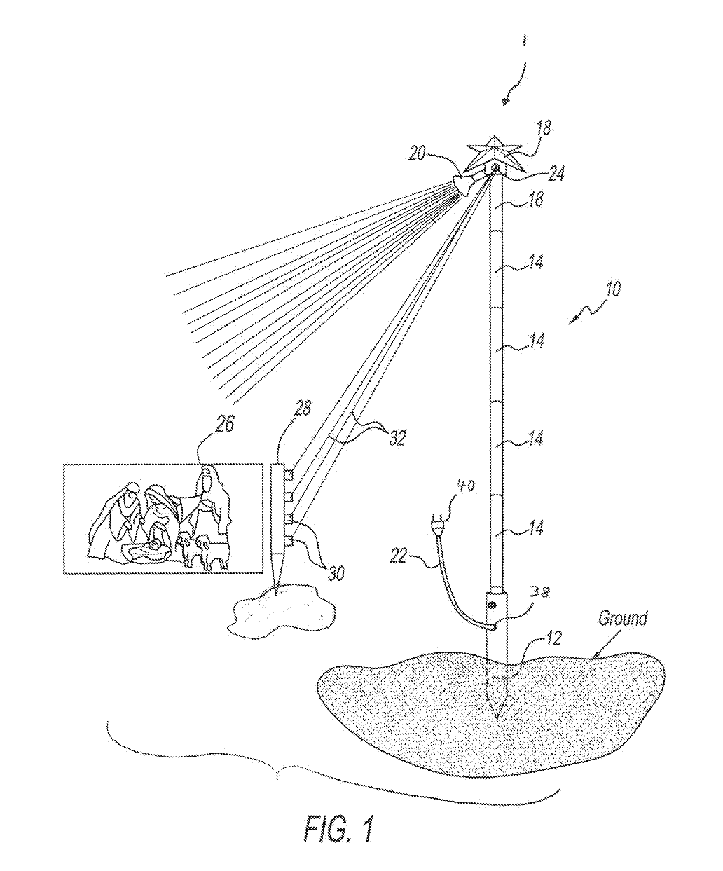

Referring to FIG. 1, there is disclosed a free standing lighted star ornament 1 comprising a free standing tubular support pole 10 which may be a telescoping pole having a bottom section 12 that can be driven into the ground and a plurality of intermediate sections 14 that extend from the bottom section 12 to a top section 16. A lighted star 18, a spot light 20 and a hook or loop 24 to which glittering strings or glittering strips material can be attached is located at the very top of the top section 16. The bottom section 12, intermediate sections 14 and the top section 16 can be made of aluminum, stainless steel, steel, plastic, etc., having any desired cross section configuration such as circular, square, rectangular, elliptical, etc.

The bottom section 12 can have a length of about four feet, more or less where the bottom end has a conical shape to allow it to be more easily driven into the ground. In a typical installation the bottom section 12 will be driven into the ground for a distance of about two feet and two feet of the bottom section 12 will project above the ground. Located about one foot from the top end of the bottom section 12 is at least one opening 38 which can be round with a diameter of one and three-quarters of an inch. This opening 38 is a clearance opening for an electrical connector such as a waterproof male plug 40 attached to a three wire waterproof electrical cable 22.

The intermediate sections 14 can be similar where each section can have a length of about five feet, more or less. The top section 16 can have a length of about five feet, more or less, and is adapted to be connected at its top end to a star 18 that can be illuminated and at least one spotlight 20 that can be oriented to illuminate any specific scene on the ground. In this embodiment the light in the star 18 can be a forty watt bulb and the spot light 20 can be a sixty watt bulb. It is understood that the bulb in the star 18 and the spot light 20 can have larger or smaller wattages.

The various sections, the bottom section 12, the intermediate sections 14, and the top section 16 can be connected together with bolts and nuts or any other type of connection. In the embodiment disclosed, six telescoping sections, including the bottom section 12, the intermediate sections 14, and the top section 16 are shown. It is understood that the free standing pole 10 which is shown as having a height of about thirty feet, more or less, can include additional intermediate sections 14 to increase its height or intermediate sections 14 can be removed to decrease its height. The three wire waterproof cable 22 extends without an interruption from the star 18 and lights 20 at the top of the top section 16, down thru each intermediate section 14 and out thru the clearance opening 38 in the bottom section 12. The end of the electrical cable 22 that extends from the bottom section 12 has a waterproof male connector 40 that can connect to a waterproof female connector (not shown in FIG).

As noted, existing Christmas nativity sets are missing a very important piece, the RAYS of the star that shined on the manger and led the three Kings to the newborn Jesus. This invention fills that gap.

Located near a nativity set 26 is a pole 28 that has a length of about seven feet where two feet of the pole is buried in the ground for support. The pole 28 has a plurality of hooks 30 such as, for example twenty four hooks 30 to which glittering strings or strips of glittering fabric or plastic 32 can be attached. The glittering strings or strips 32 are stretched from the hook or loop 24 at the top of the pole 10 to the hooks 30 on the pole 28 which is located near the nativity 26 scene.

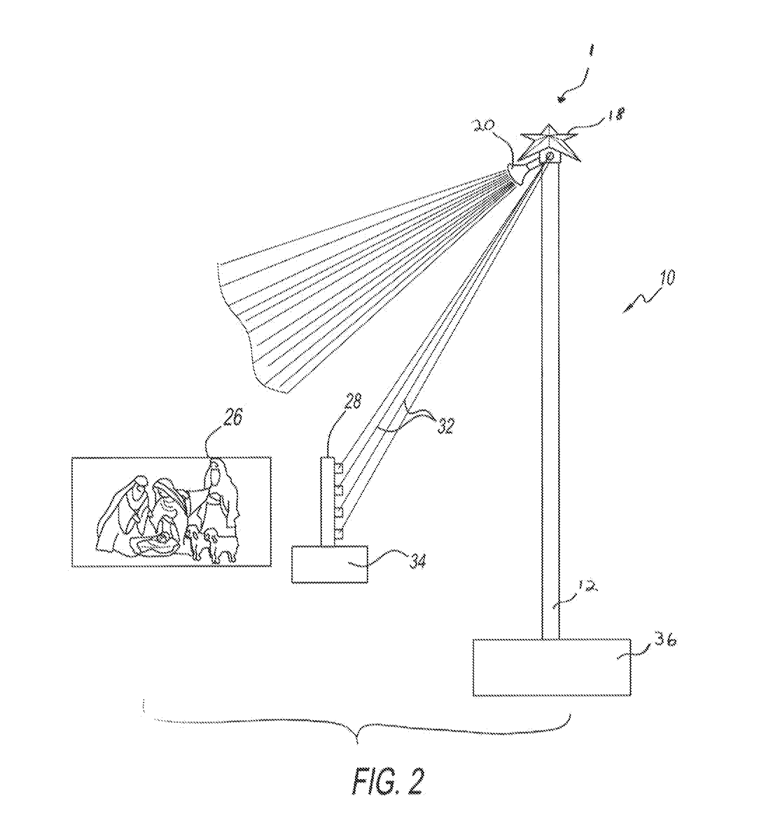

Referring to FIG. 2, there is shown a view of another embodiment of a free standing lighted star ornament 1 which comprises a standing lighted star 18 in combination with a spot light 20 and glittering strings 32 that can be oriented to shine on and illuminate an object located in an enclosed area such as a large room or an indoor arena. In this embodiment the bottom section 12 of the free standing pole 10 is placed into a wide container 36 which is filled with wet sand for support where the size of the container is determined by the height of the pole 10. For example, the container 36 may have a depth of about four feet and a diameter of five feet for a 30 feet tall free standing pole 10. In a similar manner, the bottom end of the pole 28 near the nativity scene 26 is placed into a wide container 34 which is filled with wet sand for support. For pole 28, the container 34 may have a depth of one and one half feet and a diameter of four feet.

The invention disclosed can be used with existing nativity sets, indoor or outdoor, to depict the star with its glittering rays of strings or strips of fabric or plastic lighting up the manger. The height of the star can be adjusted. The length and brightness of the rays from the star can be adjusted. The length of the rays from the star to the manger can be adjusted. The intensity of the rays is adjustable. The rays can also be steady, flickering or running.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A free standing lighted star ornament, comprising:
a star having a light that transmits lights in a plurality of directions;
at least one spot light that can be oriented to illuminate any specific scene on the ground;
a tubular support pole, having a top section, a plurality of intermediate sections, and a bottom section connected together, wherein the top section of the tubular support pole is attached to the star and to the at least one spot light; and
a waterproof electrical cable that extends through the pole from the top section to the bottom section is connected at one end to the star and the at least one spot light and adapted to be connected at its other end to a source of power.

2. The free standing lighted star ornament of claim 1 further comprising a pole designed to be located near the nativity scene for hanging glittering strings.

3. The free standing lighted star ornament of claim 1 further comprising a hook or loop attached to the top section of the tubular support pole for hanging glittering strings, wherein the glittering strings are stretched from the hook or loop on the tubular support pole to the pole located near the nativity scene.

4. The free standing lighted star ornament of claim 1, wherein the tubular support pole has an adjustable height, preferably a height of approximately 30 feet.

5. The free standing lighted star ornament of claim 1, wherein the number of the plurality of intermediate sections can be increased to increase the total height of the tubular support pole or reduced to decrease the total height of the tubular support pole.

6. The free standing lighted star ornament of claim 1, wherein the bottom section of the tubular support pole has a conical shape at its bottom end and is partially driven into the ground for support.

7. The free standing lighted star ornament of claim 1, wherein the bottom section of the tubular support pole is placed into a wide container which is filled with wet sand for support.

8. The free standing lighted star ornament of claim 1, wherein the pole designed to be located near the nativity scene for hanging glittering strings is partially buried in the ground for support.

9. The free standing lighted star ornament of claim 1, wherein the bottom section of the pole designed to be located near the nativity scene is placed into a wide container which is filled with wet sand for support.

10. The free standing lighted star ornament of claim 1, wherein the tubular support pole having any desired cross section configuration of circular, square, rectangular, and elliptical.

11. The free standing lighted star ornament of claim 1, wherein the tubular support pole can be made of any material of aluminum, stainless steel, steel, and plastic.

12. The free standing lighted star ornament of claim 1, wherein the intensity and brightness of the star and the at least one spot light can be adjusted.

13. A free standing lighted star ornament, comprising:
a star having a light that transmits lights in a plurality of directions;
at least one spot light that can be oriented to illuminate any specific scene on the ground;
a tubular support pole, having a top section, a plurality of intermediate sections, and a bottom section connected together, wherein the top section of the tubular support pole is attached to the star and to the at least one spot light;
a pole designed to be located near the nativity scene for hanging glittering strings having a plurality of hooks;
a hook or loop attached to the top section of the tubular support pole for hanging glittering strings, wherein glittering strings are stretched from the hook or loop on the tubular support pole to the hooks on the pole located near the nativity scene; and
a waterproof electrical cable that extends thru the pole from the top section to the bottom section is connected at one end to the star and the at least one spot light and adapted to be connected at its other end to a source of power.

14. The free standing lighted star ornament of claim 13, wherein the bottom section of the tubular support pole is partially driven into the ground for support.

15. The free standing lighted star ornament of claim 13, wherein the bottom section of the tubular support pole is placed into a wide container which is filled with wet sand for support.

16. The free standing lighted star ornament of claim 13, wherein the bottom section of the pole located near the nativity scene is placed into a wide container which is filled with wet sand for support.

17. A free standing lighted star ornament, comprising:
a star having a light that transmits lights in a plurality of directions;
at least one spot light that can be oriented to illuminate any specific scene on the ground;
a tubular support pole, having a top section, a plurality of intermediate sections, and a bottom section connected together, wherein the top section of the tubular support pole is attached to the star and to the at least one spot light;
a plurality of glittering strings and strips made of glittering fabric or plastic;
a pole designed to be located near the nativity scene for hanging glittering strings having a plurality of hooks;
a hook or loop attached to the top section of the tubular support pole for hanging glittering strings, wherein the glittering strings are stretched from the hook or loop on the tubular support pole to the hooks on the pole located near the nativity scene;
a waterproof electrical cable that extends thru the pole from the top section to the bottom section is connected at one end to the star and the at least one spot light and adapted to be connected at its other end to a source of power; and
a nativity set.

18. The free standing lighted star ornament of claim 17, wherein the bottom section of the tubular support pole is partially driven into the ground for support.

19. The free standing lighted star ornament of claim 17, wherein the bottom section of the tubular support pole is placed into a wide container which is filled with wet sand for support.

20. The free standing lighted star ornament of claim 17, wherein the bottom section of the pole located near the nativity scene is placed into a wide container which is filled with wet sand for support.
